(19) United States
(12) Patent Application Publication
(10) Pub. No.: US 2010/0185604 A1
(43) Pub. Date: Jul. 22, 2010

(54) Search Results Embedded in a Table-Of-Contents

(75) Inventors: Susann Marie Keohane, Austin, TX (US); Gerald Francis McBrearty, Austin, TX (US); Shawn Patrick Mullen, Buda, TX (US); Jessica Carol Murillo, Round Rock, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: INTERNATIONAL BUSINESS MACHINES CORPORATION, Armonk, NY (US)

(21) Appl. No.: 12/353,325

(22) Filed: Jan. 14, 2009

(51) Int. Cl. G06F 17/30

(52) U.S. Cl. 707/722; 707/E17.014; 707/E17.017

(57) ABSTRACT

A computer implemented method, a computer program product, and a data processing system for presenting search results in the context of a table-of-contents. A keyword search term and a stratum-level are identified. An occurrence of the keyword search term is then identified from a searched document. The occurrence of the keyword search term is then presented within a context of a table-of-contents of the searched document, wherein the occurrence of the keyword search term is presented according to the indicated stratum-level.

### BACKGROUND OF THE INVENTION

1. Field of the Invention

The embodiments of the invention relate generally to a computer implemented method, a data processing system, and a computer program product. More specifically, the embodiments of the invention relate to a computer implemented method, a data processing system, and a computer program product for presenting search results in the context of a table-of-contents.

2. Description of the Related Art

With the increasing amount of information that is available to users via today's computer systems, efficient techniques for locating information of interest are becoming essential. Even if a user locates a document of interest, often times, information is scattered throughout the document. A user is then forced to review, or search the document for occurrences of the specific topic of interest.

However, when searching documents, it is often difficult to identify and display the useful information distributed in a document in a format that is easily accessible to the user. Different occurrences of the topic of interest can be distributed throughout the document, such that simultaneous display of those occurrences within a browser window is difficult at best. If a user wants to simultaneously display several occurrences of remotely located useful information in a document within a browser window, the user will typically have two choices. First, a user can launch multiple browser window screens for the same document application, and then locate appropriate occurrences of the topic for display in the separate browser windows. Alternatively, if the browser application has a split screen functionality, the user can split the individual portion of the window. A search can then be performed for the appropriate occurrences of the topic for display, and those occurrences displayed within each split view.

Current search results are presented in a myopic manner. The search results allow a user to skip through the document with a “next” button, jumping to a subsequent location of the searched term. The user can then view the particular occurrence of the search result within its surrounding text, before jumping to the next occurrence of the particular search term.

### BRIEF SUMMARY OF THE INVENTION

The illustrative embodiments describe a computer implemented method, a computer program product, and a data processing system for presenting search results in the context of a table-of-contents. A keyword search term and a stratum-level are identified. An occurrence of the keyword search term is then identified from a searched document. The occurrence of the keyword search term is then presented within a context of a table-of-contents of the searched document, wherein the occurrence of the keyword search term is presented according to the indicated stratum-level.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a dataflow diagram depicting the various components for presenting search results in the context of a table-of-contents according to an illustrative embodiment;

FIG. 4A are search results of a keyword search for a first stratum-level according to an illustrative embodiment;

FIG. 4B are search results of a keyword search for a second stratum-level according to an illustrative embodiment;

FIG. 4C are search results of a keyword search for a third stratum-level according to an illustrative embodiment; and

FIG. 5 is a flowchart of processing steps for searching a document for a keyword search term and presenting search results in the context of a table-of-contents according to an illustrative embodiment

### DETAILED DESCRIPTION OF THE INVENTION

As will be appreciated by one skilled in the art, the embodiments of the invention include a system, method, or computer program product. Accordingly, the embodiments of the invention include may take the form of an entirely hardware embodiment, an entirely software embodiment (including firmware, resident software, micro-code, etc.), or an embodiment combining software and hardware aspects that may all generally be referred to herein as a “circuit,” “module”, or “system.” Furthermore, the embodiments of the invention include may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note, that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the embodiments of the invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

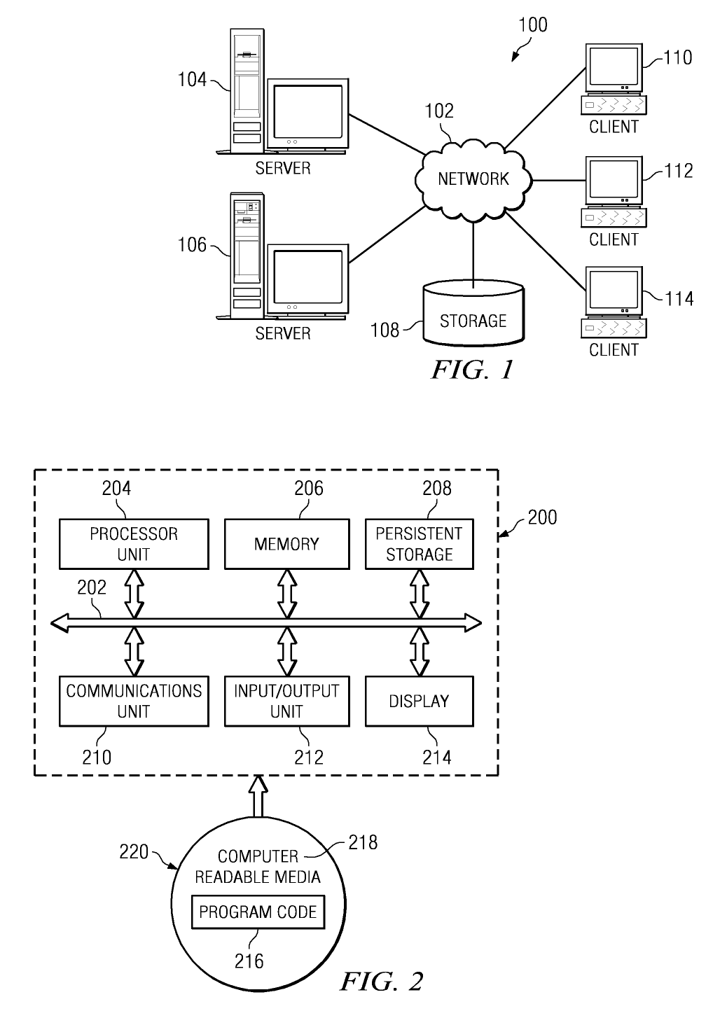

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wires, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

The illustrative embodiments describe a computer implemented method, a computer program product, and a data processing system for presenting search results in the context of a table-of-contents. A keyword search term and a stratum-level are identified. An occurrence of the keyword search term is then identified from a searched document. The occurrence of the keyword search term is then presented within a context of a table-of-contents of the searched document, wherein the occurrence of the keyword search term is presented according to the indicated stratum-level.

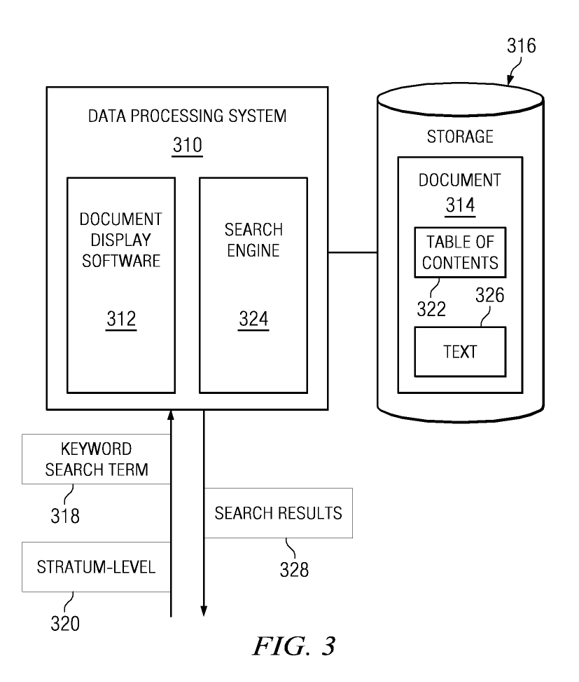

Referring now to FIG. 3, a dataflow diagram depicting the various components for presenting search results in the context of a table-of-contents is shown according to an illustrative embodiment. Data processing system 310 can be one of clients 110, 112, and 114 of FIG. 1.

Data processing system 310 contains document display software 312. Document display software 312 is a software component capable of accessing and displaying documents.

Document display software 312 accesses document 314. Document 314 is stored in storage 316. Storage 316 can be storage unit 108 of FIG. 1. While document 314 is shown as existing within storage 316, it is appreciated that document 314 can exist elsewhere, such as, for example, without limitation, on a local storage device within data processing system 310.

A user inputs keyword search term 318 into data processing system 310. Keyword search term 318 is a line or string that a user wishes to locate within document 314. A user can also enter stratum-level 320. Stratum-level 320 is an indication of which layer of the headings and subheadings within table-of-contents 322 should be displayed in context with the search.

Data processing system 310 utilizes search engine 324 to parse document 314 for occurrences of keyword search term 318. Search engine 324 is a software process, which can be implemented as a packaged part of document display software 312, or as a separate plug-in component that works in conjunction with document display software 312.

Document 314 includes table-of-contents 322 and text 326. Table-of-contents 322 is a listing of various headings and subheadings within document 314. The various headings and subheadings of table-of-contents 322 correspond to sections of text 326. Text 326 is the main body of material in document 314.

Document display software 312 then presents search results 328 to the user. Search results 328 are the occurrences of keyword search term 318 within text 326. Search results 328 are presented to the user within the context of table-of-contents 322, according to stratum-level 320 entered by the user. Document display software 312 receives a parse from search engine 324 of each occurrence of keyword search term 318 within document 314. Document display software 312 then overlays each of these occurrences into a contiguous sequence within the context of table-of-contents 322. Document display software 312 also can filter the contiguous sequence listing of search results 328 to display a surrounding context of table-of-contents 322 corresponding to stratum-level 320 entered by the user.

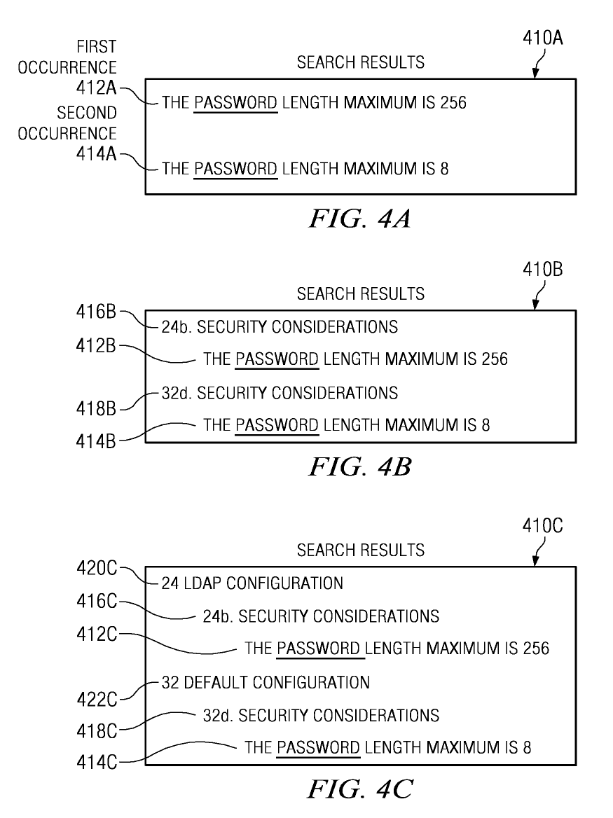

Referring now to FIG. 4A, search results of a keyword search for a first stratum-level are shown according to an illustrative embodiment. Search results 410A can be search results 328 of FIG. 3. A user has indicated that a document should be searched for the keyword “password.” Search results 410A correspond to a first indicated stratum-level, which can be stratum-level 320 of FIG. 3.

Search results 410A give a sequential listing for each occurrence of the keyword “password” within the searched document. Search results 410A indicate that the keyword “password” is found twice within the searched document. First occurrence 412A states, “The password length maximum is 256.” Second occurrence 414A states, “The password length maximum is 8.” Thus, based only on the search results, conflicting information is seemingly presented. A user is then forced to navigate to the cited section and read the context surrounding each of first occurrence 412A and second occurrence 414A in order to determine which section contains the user's desired information.

Search results 410A for the first stratum level provide only a listing of the search terms. While a stratum-level may have been indicated, the surrounding context of the searched term according to the prior art is not presented.

Referring now to FIG. 4B, search results of a keyword search for a second stratum-level are shown according to an illustrative embodiment. Search results 410B can be search results 328 of FIG. 3. A user has indicated that a document should be searched for the keyword “password.” Search results 410B correspond to a second indicated stratum-level, which can be stratum-level 320 of FIG. 3.

Search results 410B give a sequential listing for each occurrence of the keyword “password” within the searched document. Search results 410B indicate that the keyword “password” is found twice within the searched document. First occurrence 412B states, “The password length maximum is 256.” Second occurrence 414B states, “The password length maximum is 8.”

Search results 410B correspond to a second indicated stratum-level, therefore, the search results 410B also include subheading 416B and subheading 418B. Subheading 416B and subheading 418B are ones of the various headings and subheadings within a table-of-contents, such as table-of-contents 322 of FIG. 3. Subheading 416B provides a level of context for first occurrence 412B. Subheading 416B provides that first occurrence 412B is located within the section “24.b. Security Considerations” of the searched document.

Similarly, subheading 418B provides a level of context for second occurrence 414B. Subheading 418B provides that second occurrence 414B is located within the section “32.d. Security Considerations” of the searched document.

Referring now to FIG. 4C, search results of a keyword search for a third stratum-level are shown according to an illustrative embodiment. Search results 410C can be search results 328 of FIG. 3. A user has indicated that a document should be searched for the keyword “password.” Search results 410C correspond to a third indicated stratum-level, which can be stratum-level 320 of FIG. 3.

Search results 410C give a sequential listing for each occurrence of the keyword “password” within the searched document. Search results 410C indicate that the keyword “password” is found twice within the searched document. First occurrence 412C states, “The password length maximum is 256.” Second occurrence 414C states, “The password length maximum is 8.”

Search results 410C correspond to a third indicated stratum-level, therefore, the search results 410C also include subheading 416C and subheading 418C. Subheading 416C and subheading 418C are ones of the various headings and subheadings within a table-of-contents, such as table of contents 322 of FIG. 3. Subheading 416C provides a level of context for first occurrence 412C. Subheading 416C provides that first occurrence 412C is located within the subsection “24.b. Security Considerations” of the searched document.

Similarly, subheading 418C provides a level of context for second occurrence 414C. Subheading 418C provides that second occurrence 414C is located within the subsection “32.d. Security Considerations” of the searched document.

Search results 410C correspond to a third indicated stratum-level, therefore, the search results 410C also include heading 420C and heading 422C. Heading 420C and heading 422C are ones of the various headings and subheadings within a table-of-contents, such as table of contents 322 of FIG. 3. Heading 420C provides a level of context for first occurrence 412C. Heading 420C provides that first occurrence 412C is located within the section “24. LDAP Configurations” of the searched document.

Similarly, heading 422C provides a level of context for second occurrence 414C. Subheading 422C provides that second occurrence 414C is located within the section “32. Default Configuration” of the searched document.

Thus, by indicating a stratum-level for the surrounding context according to a table-of-contents, a user can immediately locate a section of interest within a document, without having to navigate to each occurrence of a searched term.

It is appreciated that FIGS. 4A-4C describe a “bottom-up” presentation of search results in the context of a table-of-contents. In a “bottom-up” presentation, a first indicated stratum-level will indicate the search term. Additional stratum-levels in a “bottom-up” presentation will add the hierarchical sub-headings and headings in an un-nesting manner, until a chapter title or main heading within the table-of-contents is listed. However, it should be appreciated that while the Figures describe a “bottom-up” presentation, the illustrative embodiments herein also encompass a “top-down” presentation of search results in the context of a table-of-contents. In a “top-down” presentation, an indicated stratum-level will indicate the search term. However, additional stratum-levels in a “top-down” presentation begin at a chapter title or main heading within the table-of-contents is listed, and then work down the hierarchical sub-headings and headings until the stratum-level indicates the specific subheading in which the search term is found.

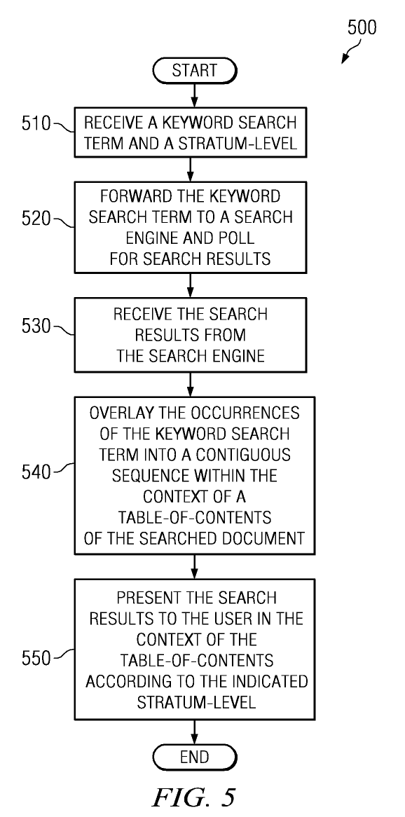

Referring now to FIG. 5, a flowchart of processing steps for searching a document for a keyword search term and presenting search results in the context of a table-of-contents is shown according to an illustrative embodiment. Process 500 is a software process, executing on a software component, such as document display software 312 of FIG. 3.

Process 500 begins by receiving a keyword search term and a stratum-level (step 510). The keyword search term is a line or string that a user wishes to locate within the searched document. This keyword search term can be keyword search term 318 of FIG. 3. Stratum-level is an indication of which layer of the headings and subheadings within a table-of-contents should be displayed in context with the search. Stratum-level can be stratum-level 320 of FIG. 3.

Responsive to receiving a keyword search term, process 500 forwards the keyword search term to a search engine and polls for search results (step 520). The search engine can be search engine 324 of FIG. 3. The search engine parses the searched document for occurrences of the keyword search term. The search engine then forwards the search results back to the document display software.

Process 500 receives the search results from the search engine (step 530). The search results contain the occurrences of the keyword search term within the text of the searched document. Responsive to receiving the search results, process 500 overlays the occurrences of the keyword search term into a contiguous sequence within the context of a table-of-contents of the searched document (step 540).

Process 500 then presents the search results to the user in the context of the table-of-contents according to the indicated stratum-level (step 550), with the process terminating thereafter. Thus, the headings and subheadings within table-of-contents are presented with the searched keyword term, according to the indicated stratum-level.

Thus, the illustrative embodiments described herein provide a computer implemented method, a computer program product, and a data processing system for presenting search results in the context of a table-of-contents. A keyword search term and a stratum-level are identified. An occurrence of the keyword search term is then identified from a searched document. The occurrence of the keyword search term is then presented within a context of a table-of-contents of the searched document, wherein the occurrence of the keyword search term is presented according to the indicated stratum-level.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment, or an embodiment containing both hardware and software elements. In an illustrative embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the embodiments of the invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for presenting search results in the context of a table-of-contents comprising the computer implemented steps of:
identifying a keyword search term and a stratum-level, wherein the stratum-level indicates a layer within table-of-contents that to be displayed in the search results;
identifying an occurrence of the keyword search term within a searched document; and
responsive to identifying the occurrence of the keyword search term, presenting the occurrence of the keyword search term within a context of a table-of-contents of the searched document, wherein the occurrence of the keyword search term is presented according to the indicated stratum-level.

2. The computer implemented method of claim 1, wherein the stratum-level is an indication of which of headings and subheadings within the table-of-contents should be displayed.

3. The computer implemented method of claim 2, wherein the step of identifying a keyword search term and a stratum-level further comprises:
selecting the stratum-level from a plurality of stratum-levels.

4. The computer implemented method of claim 3, wherein the step of presenting the occurrence of the keyword search term within a context of a table-of-contents of the searched document further comprises:
presenting the occurrence of the keyword search term within a context of a table-of-contents of the searched document, wherein the stratum-level selected from the plurality of stratum-levels is a first stratum-level, and wherein the first stratum-level provides a listing of the keyword search term without a surrounding context of the searched term from the table-of-contents.

5. The computer implemented method of claim 3, wherein the step of presenting the occurrence of the keyword search term within a context of a table-of-contents of the searched document further comprises:
presenting the occurrence of the keyword search term within a context of a table-of-contents of the searched document, wherein the stratum-level selected from the plurality of stratum-levels is a second stratum-level, and wherein the second stratum-level provides a listing of the keyword search term in a surrounding context of at least one subheading from the table-of-contents, wherein the occurrence of the keyword search term is located in a text corresponding to the at least one subheading.

6. The computer implemented method of claim 3, wherein the step of presenting the occurrence of the keyword search term within a context of a table-of-contents of the searched document further comprises:
presenting the occurrence of the keyword search term within a context of a table-of-contents of the searched document, wherein the stratum-level selected from the plurality of stratum-levels is a third stratum-level, and wherein the third stratum-level provides a listing of the keyword search term in a surrounding context of both at least one subheading and at least one heading from the table-of-contents, wherein the occurrence of the keyword search term is located in a text corresponding to the at least one subheading and the at least one heading.

7. The computer implemented method of claim 1, wherein the occurrence of the keyword search term is a plurality of occurrences of the keyword search term, and wherein the computer implemented method further comprises:
overlaying each of the plurality of occurrences of the keyword search term into a contiguous sequence within the context of the table-of-contents.

8. The computer implemented method of claim 6, wherein the step of presenting the occurrence of the keyword search term within the context of the table-of-contents of the searched document further comprises:
responsive to identifying the plurality of occurrences of the keyword search term, presenting the plurality of occurrences of the keyword search term within the context of the table-of-contents of the searched document, wherein the plurality of occurrences of the keyword search term are presented according to the indicated stratum-level in the contiguous sequence within the context of the table-of-contents.

9. A computer-readable medium for presenting search results in the context of a table-of-contents, the computer-readable medium comprising:
a computer program product encoded thereon comprising:
computer usable program code for identifying a keyword search term and a stratum-level, wherein the stratum-level indicates a layer within table-of-contents that to be displayed in the search results;
computer usable program code for identifying an occurrence of the keyword search term within a searched document; and
computer usable program code, responsive to identifying the occurrence of the keyword search term, for presenting the occurrence of the keyword search term within a context of a table-of-contents of the searched document, wherein the occurrence of the keyword search term is presented according to the indicated stratum-level.

10. The computer-readable medium of claim 9, wherein the stratum-level is an indication of which of headings and subheadings within the table-of-contents should be displayed.

11. The computer-readable medium of claim 10, wherein the a computer program product encoded thereon further comprises:
computer usable program code for selecting the stratum-level from a plurality of stratum-levels.

12. The computer-readable medium of claim 11, wherein the computer usable program code for presenting the occurrence of the keyword search term within a context of a table-of-contents of the searched document further comprises:
computer usable program code for presenting the occurrence of the keyword search term within a context of a table-of-contents of the searched document, wherein the stratum-level selected from the plurality of stratum-levels is a first stratum-level, and wherein the first stratum-level provides a listing of the keyword search term without a surrounding context of the searched term from the table-of-contents.

13. The computer-readable medium of claim 11, wherein the computer usable program code for presenting the occurrence of the keyword search term within a context of a table-of-contents of the searched document further comprises:
computer usable program code for presenting the occurrence of the keyword search term within a context of a table-of-contents of the searched document, wherein the stratum-level selected from the plurality of stratum-levels is a second stratum-level, and wherein the second stratum-level provides a listing of the keyword search term in a surrounding context of at least one subheading from the table-of-contents, wherein the occurrence of the keyword search term is located in a text corresponding to the at least one subheading.

14. The computer-readable medium of claim 11, wherein the computer usable program code for presenting the occurrence of the keyword search term within a context of a table-of-contents of the searched document further comprises:
computer usable program code for presenting the occurrence of the keyword search term within a context of a table-of-contents of the searched document, wherein the stratum-level selected from the plurality of stratum-levels is a third stratum-level, and wherein the third stratum-level provides a listing of the keyword search term in a surrounding context of both at least one subheading and at least one heading from the table-of-contents, wherein the occurrence of the keyword search term is located in a text corresponding to the at least one subheading and the at least one heading.

15. The computer-readable medium of claim 9, wherein the occurrence of the keyword search term is a plurality of occurrences of the keyword search term, and wherein the computer usable program code further comprises:
computer usable program code for overlaying each of the plurality of occurrences of the keyword search term into a contiguous sequence within the context of the table-of-contents.

16. The computer-readable medium of claim 15, wherein the computer usable program code for presenting the occurrence of the keyword search term within the context of the table-of-contents of the searched document further comprises:
computer usable program code, responsive to identifying the plurality of occurrences of the keyword search term, for presenting the plurality of occurrences of the keyword search term within the context of the table-of-contents of the searched document, wherein the plurality of occurrences of the keyword search term are presented according to the indicated stratum-level in the contiguous sequence within the context of the table-of-contents.

17. A data processing system comprising:
a bus;
a communications unit connected to the bus;
a storage device connected to the bus, wherein the storage device includes computer usable program code for presenting search results in the context of a table-of-contents; and
a processor unit connected to the bus, wherein the processor unit executes the computer usable program code to identify a keyword search term and a stratum-level, wherein the stratum-level indicates a layer within table-of-contents that to be displayed in the search results, wherein identifying the stratum-level comprises selecting the stratum-level from a plurality of stratum-levels, wherein the stratum-level is an indication of which of headings and subheadings within the table-of-contents should be displayed; to identify an occurrence of the keyword search term within a searched document; and responsive to identifying the occurrence of the keyword search term, to present the occurrence of the keyword search term within a context of a table-of-contents of the searched document, wherein the occurrence of the keyword search term is presented according to the indicated stratum-level.

18. The data processing system of claim 17, wherein processor unit executing the computer usable program code to present the occurrence of the keyword search term within a context of a table-of-contents of the searched document further comprises:
the processor unit executing the computer usable program code to present the occurrence of the keyword search term within a context of a table-of-contents of the searched document, wherein the stratum-level selected from the plurality of stratum-levels is a first stratum-level, and wherein the first stratum-level provides a listing of the keyword search term without a surrounding context of the searched term from the table-of-contents.

19. The data processing system of claim 17, wherein processor unit executing the computer usable program code to present the occurrence of the keyword search term within a context of a table-of-contents of the searched document further comprises:
the processor unit executing the computer usable program code to present the occurrence of the keyword search term within a context of a table-of-contents of the searched document, wherein the stratum-level selected from the plurality of stratum-levels is a second stratum-level, and wherein the second stratum-level provides a listing of the keyword search term in a surrounding context of at least one subheading from the table-of-contents, wherein the occurrence of the keyword search term is located in a text corresponding to the at least one subheading.

20. The data processing system of claim 17, wherein processor unit executing the computer usable program code to present the occurrence of the keyword search term within a context of a table-of-contents of the searched document further comprises:
the processor unit executing the computer usable program code to present the occurrence of the keyword search term within a context of a table-of-contents of the searched document, wherein the stratum-level selected from the plurality of stratum-levels is a third stratum-level, and wherein the third stratum-level provides a listing of the keyword search term in a surrounding context of both at least one subheading and at least one heading from the table-of-contents, wherein the occurrence of the keyword search term is located in a text corresponding to the at least one subheading and the at least one heading.
